(19) United States
(12) Patent Application Publication
(10) Pub. No.: US 2012/0308804 A1
(43) Pub. Date: Dec. 6, 2012

(54) Molded foam body having anisotropic shape memory properties, method for manufacturing same and article comprising the molded foam body

(75) Inventors: Andreas Lendlein, Berlin (DE); Samy Madbouly, Cairo (EG); Andreas Klein, Berlin (DE); Karl Kratz, Berlin (DE); Karola Lützow, Berlin (DE)

(73) Assignee: Helmholtz-Zentrum Geesthacht Zentrum fur Material-Und Kustenforschung GmbH, Geesthacht (DE)

(21) Appl. No.: 13/516,736

(22) PCT Filed: Nov. 23, 2010
(86) PCT No.: PCT/EP2010/068005

§ 371 Date: Aug. 11, 2012

(30) Foreign Application Priority Data
Dec. 22, 2009 (DE) 10 2009 060 940.7

(51) Int. Cl. C08J 9/12

(52) U.S. Cl. 428/221; 264/53

(57) ABSTRACT

The invention relates to a molded foam body having anisotropic shape memory properties, to a method for manufacturing such a molded foam body and to an article, which contains or is composed of such a molded foam body.

The molded foam body according to the invention comprises at least one shape memory polymer, which forms a foam structure having asymmetric pores oriented substantially in a common, first spatial direction (L). Said molded foam body is manufactured by foaming the polymer by means of the release of a gaseous propellant under conditions that promote the release and the escape of the propellant from the polymer substantially in a main flow direction. Following thermomechanical programming, such a shape memory foam exhibits a direction-dependent level of recovery and recovery forces when reheated.

The invention relates to a molded foam body having anisotropic shape memory properties, to a method for manufacturing such a molded foam body and to an article, which contains or is composed of such a molded foam body.

So-called shape memory polymers or SMPs are known in the prior art which exhibit at induction by an appropriate stimulus a shape transition from a temporary shape to a permanent shape corresponding to a previous programming. Most often this shape memory effect is thermally stimulated, that is, upon heating of the polymer material above the defined switching temperature which takes place by entropic elasticity recovery. Shape memory polymers are usually polymer networks at the molecular level, where chemical (covalent) or physical (non-covalent) crosslinks define the permanent shape. In thermoplastic elastomers the network points are of a physical nature. In addition to the network points, the shape memory polymers are composed of switching segments which specify the programmed temporary shape(s). Here the temperature-induced transition from a programmed temporary shape to the permanent shape or another temporary shape is powered by a phase transition of the switching segment either by a crystallization temperature Tₘ or a glass transition temperature T_{g}.

A shape memory functionality is obtained by the combination of the aforementioned molecular structure of the polymer and a thermomechanical conditioning (also referred to as programming). In a first, conventional processing step the permanent shape of the polymer is thereby made, for example, by injection molding or the like. The programming, i.e. the manufacturing of the temporary shape, takes place subsequently. Typically for this purpose the polymer is first heated to a temperature above the transition temperature Tₜᵣₐₙₛ of a phase formed by the switching segment (=switching phase) and the polymer material in the temporary shape is deformed at this temperature. While maintaining the deformation forces the polymer is then cooled below the transition temperature, in order to fix the temporary shape by the thereby induced phase transition of the switching phase, for example a crystallization. Reheating above the switching temperature leads to a phase transition in the reverse direction, for example melting the switching phase, and recovery of the original permanent shape. (Since the switching temperature T_{switch} as opposed to the purely material-dependent thermodynamic transition temperature Tₜᵣₐₙₛ (Tₜᵣₐₙₛ=Tₘ or T_{g}) of the work to be performed and the mechanical movement depends on who defines the macroscopic deformation both temperatures can vary slightly.) The recovery can take place either free of stress or under a predetermined load. In the case of stress-free recovery the characteristic switching temperature (T_{switch}) results from the turning point of the substantially sigmoidal extending strain-temperature curve. In the event of recovery under load, the stress-temperature curve has a characteristic maximum which defines the switching temperature (T_{σ,max}). T_{σ,max} results from two contrasting processes taking place during the heating, namely on the one hand from the increase in strength and on the other hand from the increasing softening of the plastic under increasing temperature. In addition to the above-described typical programming above Tₜᵣₐₙₛ, the programming method of cold drawing below Tₜᵣₐₙₛ or in the vicinity of Tₜᵣₐₙₛ is also described in the prior art.

It is also known that porous molded bodies (hereinafter also referred to as foams) are manufactured from shape memory polymers (e.g. A. Metcalfe et al., Biomaterials 24 (2003), 491-497). Such shape memory foams also have the ability after appropriate thermomechanical programming (see above) to take a compressed, temporarily fixed shape and after heating above the switching temperature shift back again to the original, permanent shape, i.e. expand. Shape memory foams, which exhibit a thermally induced shape memory effect consist mostly of thermoplastic elastomers (e.g. multiblock copolymers, polyester-urethanes), blends (polymer blends), or composites (polymers with an organic or inorganic filler or additive) of the aforementioned classes of plastics. The known shape memory foams are partially biocompatible, but are not known as resorbable foams.

A disadvantage of the shape memory foams described previously in the prior art is that on heating they exhibit a uniform (isotropic) expansion in all directions. An anisotropic expansion behavior, however, would be desirable for many applications. For example, the known isotropic compressed SMP foams are inserted to fill complex cavities particularly in the medical field, as described in the filling of long bones (L. M. Mathieu et al., Biomaterials 27(6) (2006), 905-916), so this can result in incomplete filling of the cavity or to undesirable mechanical deformations.

The underlying object of the present invention is therefore to make available a molded foam body having shape memory properties, which when heated can result in various recoverys in various spatial directions and exerts various recovery forces. In addition, a method is to be proposed, with which such anisotropic shape memory foams can be manufactured.

This object is achieved by a molded foam body having the features of claim 1. The molded foam body according to the invention comprises anisotropic, thermally inducible shape memory properties. Within the scope of the invention, the term ‘anisotropic shape memory properties’ is understood to be a recovery behavior of a programmed molded foam body which takes place in various spatial directions at varying degrees. In particular, this means that when heated a compressed molded foam body exhibits a different expansion in the various spatial directions with various direction-dependent expansion forces. This behavior applies also and especially to the recovery after an isotropic (direction-independent) programming. The molded foam body according to the invention comprises at least one shape memory polymer which following a suitable thermomechanical programming or mechanical programming (cold drawing) is able to implement at least one shape transition temperature-induced from a temporary shape to a permanent shape. The shape memory foam according to the invention is characterized in that it comprises a foam structure having asymmetric pores, oriented substantially in a common, first spatial direction (longitudinal spatial direction L). It has come as a particular surprise to find that if it succeeds in manufacturing a shape memory polymer foam having such an asymmetric, unidirectional pore structure, this comprises the property of performing, after an appropriate programming, different levels of expansion in different spatial directions or to implement the recovery with various direction-independent expansion forces in the various spatial directions.

Here, the degree of anisotropy can be selectively adjusted by the design of the foam morphology or the pore structure, respectively. An asymmetric pore structure is here understood to mean a ratio of an average pore dimension in the first (longitudinal) spatial direction to an average pore dimension in a second (transversal) spatial direction extending orthogonally thereto unequal to 1. In particular, the ratio of the pore dimension in the longitudinal spatial direction to the transversal spatial direction is at least 2, i.e. the average longitudinal pore diameter is at least twice as large as the transversal pore diameter. In advantageous embodiments, the ratio of the longitudinal direction to the transversal direction is at least 3, in particular at least 4 and particularly preferably at least 5. This shows that the larger this ratio, the greater the anisotropy of the shape memory effect is.

Preferably, the foam according to the invention comprises a molded foam body density in the range of 0.01 to 0.30 g/cm³, in particular from 0.02 to 0.20 g/cm³, particularly preferably from 0.07 to 0.13 g/cm³. Here, the lower threshold is limited by the fact that the polymer foam must comprise a certain recovery force (expansion force) in order to fulfill its intended function. On the other hand, in principle, a ‘biocompatible’ surface structure and a light weight is desired for foam materials, which limits the upper threshold.

At the molecular level the shape memory polymer is preferably a polymer network, which has physical (non-covalent) cross-linking sites as well as switching segments which comprise a transition temperature Tₜᵣₐₙₛ (T_{g} or Tₘ) in an acceptable range for the respective application. For example, the transition temperature of the switching segment during physiological applications ranges from 10 to 80° C. Preferably, the shape memory polymer is a physically cross-linked thermoplastic elastomer. In particular, the switching segment may be selected from the group consisting of polyesters, especially poly(ε-caprolactone); polyethers, polyurethanes, especially polyurethane; polyimides, polyetherimides, polyacrylates, polymethacrylates, polyvinyls, polystyrenes, polyoxymethyls, poly(para-dioxanone). It is further preferred that the shape memory polymer comprises hydrolytically cleavable groups, such as glycolide or lactide groups. In particular, this may include diglycolide groups, dilactide groups, polyanhydrides or polyorthoesters. Provided that a suitable portion of hydrolytically cleavable groups is present in the polymer, the foam according to the invention is resorbable (degradable). Here, the hydrolytic degradation rate can be adjusted over a wide range via the portion of hydrolytically cleavable groups.

Preferably the polymer is a copolymer having at least one hard and at least one soft segment, wherein said hard and soft segments in each case comprise at least one transition temperature such as glass transitions, phase transitions, melting temperatures or melting intervals which have a sufficient distance from one another for permitting a programming and subsequent recovery. In particular, the transition temperatures of the soft segment and hard segment should be different by at least 1 K, in particular by at least 10 K, preferably by at least 50 K and in special cases by at least 200 K. Based on the above-described polymers the transition temperatures (in this case glass transition temperatures) range from −60° C. to +250° C.

Another aspect of the invention relates to an article that consists of the molded foam body according to the invention (completely) or contains said molded foam body (for example, in sections). This can especially be an object for use in the medical, pharmaceutical or biochemical field. For example, the article may be a pharmaceutical product which contains the molded foam body according to the invention as a vehicle for a pharmaceutical agent with which it is loaded. Provided the shape memory polymer is simultaneously a biodegradable polymer (see above), the active ingredient is released with a delay. Other interesting applications include use as a medicinal product in the field of so-called tissue engineering in general, in which the article is used as a carrier for colonization of cells, as a structural body for the hard or soft tissue replacement, as mechanically active scaffold or the like.

The invention also relates to a method for manufacturing the molded foam body according to the invention having anisotropic, thermally inducible shape memory properties. The method comprises the following steps:
(a) production of a substantially homogeneous mixture of a melt of a shape memory polymer (which, after a programming, temperature-induced, is able to implement at least one shape transition from a temporary shape to a permanent shape) and a propellant or a chemical precursor of such, the propellant or the precursor being present in a first state,
(b) transfer and release of the propellant into a second, gaseous state such that the shape memory polymer and the propellant separate, wherein process parameters of the release and a geometry of a process container, in which the release of the propellant takes place, are selected in such a way that the released gaseous propellant substantially escapes from the shape memory polymer along a predetermined main flow direction, so that the shape memory polymer forms a foam structure having asymmetric pores, oriented substantially in a common, first longitudinal spatial direction (L) corresponding to the main flow direction.

According to the invention conditions are thus created during the foaming process that ensure that the released propellant escapes substantially along a preferred direction (the main flow direction) from the polymer material. This causes that the polymer material to form asymmetric pores, which are oriented according to this main flow direction (hereinafter also referred to as longitudinal direction L).

It is understood that after or during foaming a lowering of the temperature below the melting temperature of the melt takes place when solidifying (fixing) the pore structure. This can take place either by a cooling under active extraction of heat and/or by a passive cooling by means of an endothermic foaming process.

As propellant, either a chemical or a physical propellant may be used. A chemical propellant in this context means those that can be selectively stimulated to perform a chemical dissociation (for example, by means of irradiation), wherein the actual propellant forms in the gaseous state (e.g., nitrogen N₂). In this case, therefore, a chemical precursor of the actual propellant is used. Preferably, however, in the context of the present invention, a physical propellant is used which passes through no chemical reaction during the manufacturing process. Rather, the physical propellant exists in a liquid, solid or supercritical state at the temperature and the pressure applied in step a). In this case, the release of the propellant in step b) takes place by changing the temperature and/or the pressure so that the propellant passes into the gaseous state and thus leads to a separation from the polymer and to the formation of the pores. The expanding propellant simultaneously drains its ambient energy in the form of heat, whereby a cooling of the polymer below the melting temperature occurs and the resulting foam is stabilized. As a physical propellant in the context of the present invention carbon dioxide is preferably used, which in step a) exists in a supercritical state, and passes into the gaseous state in step b), in particular through a pressure reduction. Supercritical carbon dioxide has in most polymer materials a very high solubility. The absence of chemical propellants as well as inorganic or organic solvents is particularly advantageous if the resulting foams are intended for use as a medicinal product or as a temporary implant.

As already noted above, the release of the propellant in a main flow direction is caused on the one hand by the process parameters during the release and on the other hand by the choice of the geometry of the process container in which the foaming takes place. Preferably the process container is selected so that it is open on one or on both sides in the longitudinal spatial direction (the desired main flow direction of the propellant) and closed in the other spatial directions. In this way, all flow directions are closed off except the longitudinal direction, so that the propellant escapes substantially in the longitudinal direction. Another measure relating to the geometry of the process container represents the choice of its dimensions. In particular, its height-width ratio is selected so that the mixture of polymer and propellant occupies a column in the process container which in the longitudinal direction has a greater extent than in the transverse direction. In other words, a suitable process container (when filled accordingly) comprises an elongated shape wherein its width or its diameter is exceeded significantly by its height.

Process parameters during the foaming process that affect the pore morphology and in particular its asymmetry include, in particular, the foaming temperature, the foaming pressure, the proportion of propellant used in relation to the shape memory polymer and the speed with which the propellant is released in step b). Where a physical propellant is used, in particular supercritical carbon dioxide, this therefore concerns the foaming temperature, the foaming pressure, the degree of saturation of the polymer with the supercritical carbon dioxide (or the length of time the polymer is exposed to the supercritical carbon dioxide) as well as the stress release rate, with which the pressure is reduced in step b). It is specified that the higher the stress release rate, the greater the asymmetry of the pores and thus the anisotropy of the shape memory effect. In particular, a pressure reduction rate of 0.1 bar/s to 100 bar/s, preferably of at least 10 bar/s, particularly preferably of at least 15 bar/s and very particularly preferably of at least 20 bar/s is used.

Provided that—as already described above—the foam is to be equipped with a pharmaceutically agent, then this can be effected in a particularly simple and gentle way, if the agent is dissolved in the liquid or supercritical propellant, for example, in the supercritical carbon dioxide and the polymer in step (a) is loaded with this mixture. It is understood that other substances than pharmaceutical agents may also be introduced in this way. As a result, following the stress release the substance is present as a solid or liquid finely dispersed in the foam.

The thermomechanical programming of the molded foam body takes place in a step c) directly or indirectly following the foaming in step b), preferably in that the molded foam body is deformed corresponding to a desired temporary shape (in particular, compressed) at a material temperature above the switching temperature of the shape memory polymer or of the switching segment, and, while maintaining the deformation constrain, is cooled at a temperature below the switching temperature, wherein the temporary shape enforced by the deformation is fixed. The recovery of the permanent (expanded) shape takes place by heating the material at a temperature above the switching temperature of the material. Alternatively, as already explained at the beginning, the programming may also be effected by so-called cold drawing, wherein the deformation occurs at temperatures below or near the switching temperature.

Other preferred embodiments of the invention are the result of other features referred to in the dependent claims.

The invention is explained subsequently in exemplary embodiments by the accompanying drawings. It exhibits:

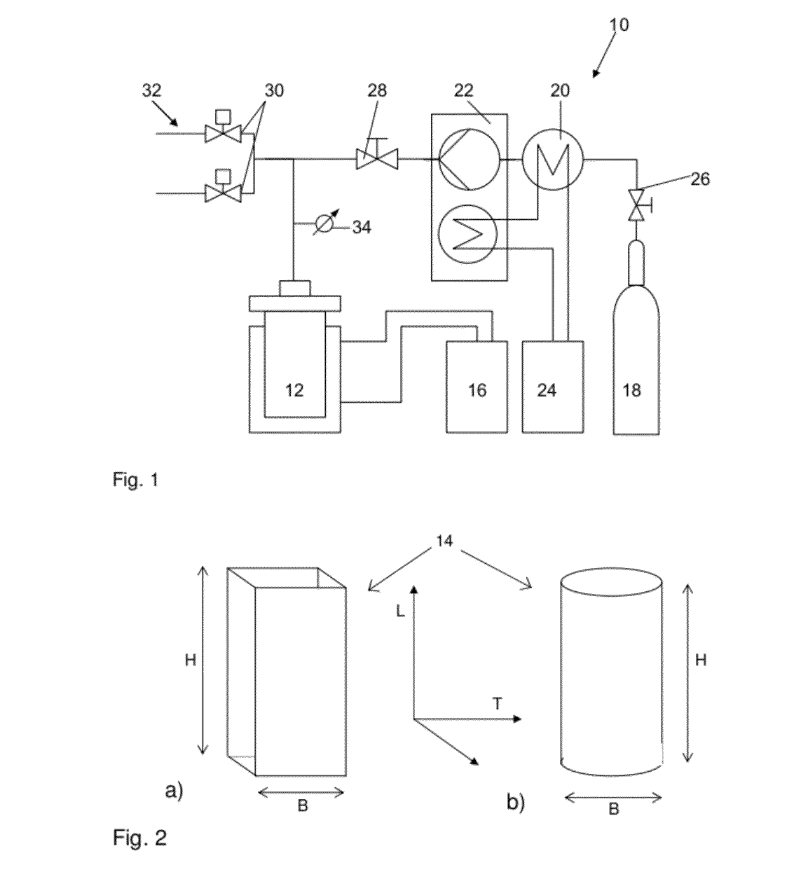

FIG. 1 a schematic example of a foaming apparatus for producing the foam according to the invention having an asymmetric pore structure;

FIGS. 2 a)-b) examples of process containers for use in a device according to FIG. 1;

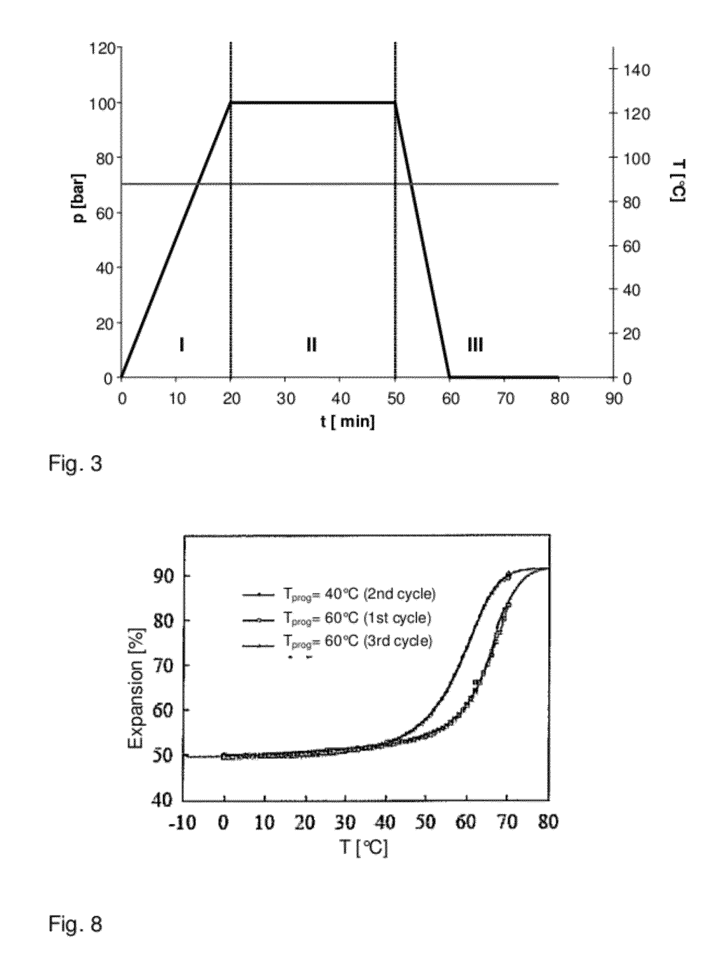

FIG. 3 chronological sequence of the process parameters of pressure and sample temperature during the foaming process;

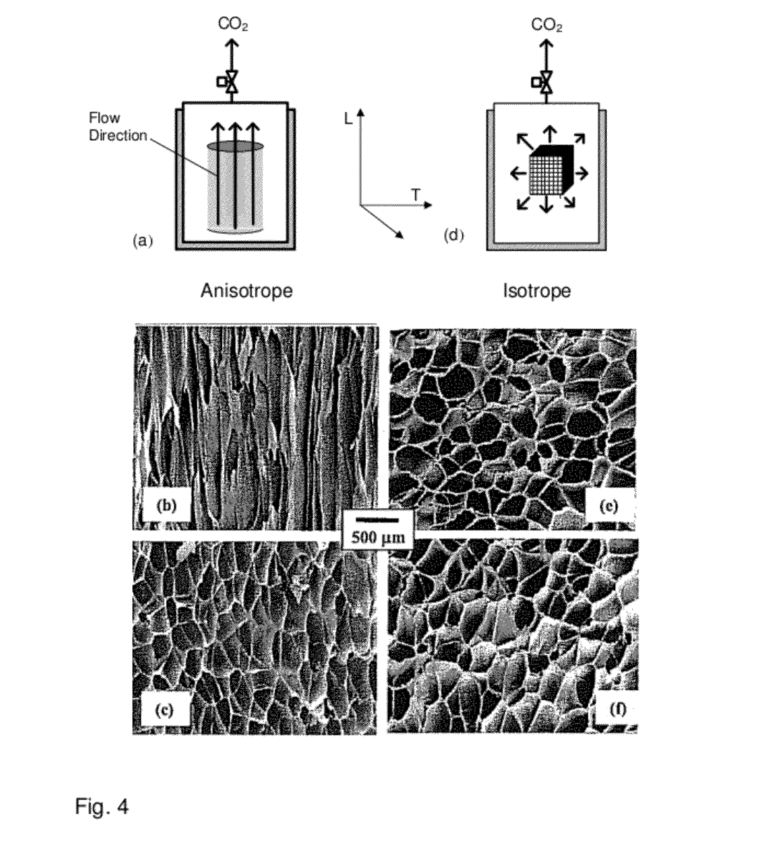

FIGS. 4 a)-c) experimental setup for generating an anisotropic SMP foam (a) and EM pictures of a section through a foam generated in such a way in the longitudinal (b) and transversal (c) level;

FIGS. 4 d)-f) experimental setup for generating an anisotropic SMP foam (d) and EM pictures of a section through a foam generated in such a way in the longitudinal (b) and transversal (c) level;

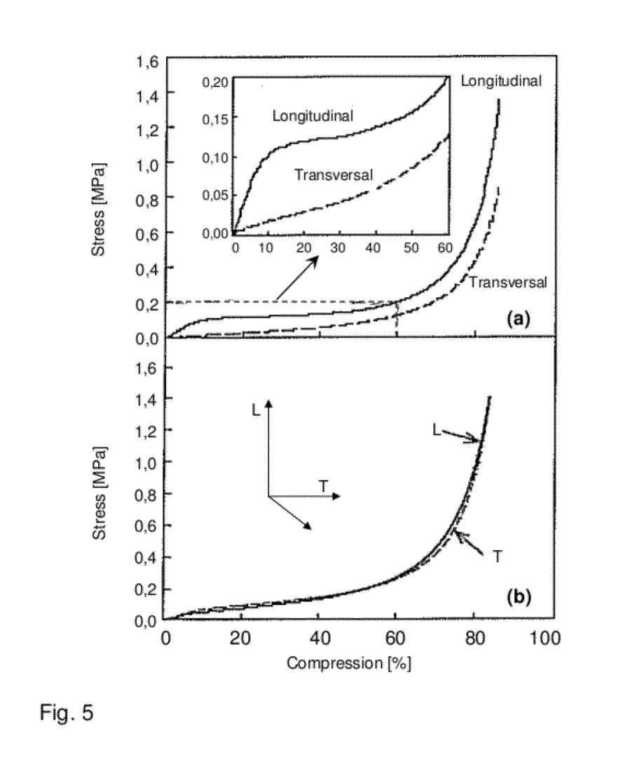

FIG. 5 mechanical properties of an unprogrammed anisotropic (a) and isotropic (b) SMP foam in a compression test;

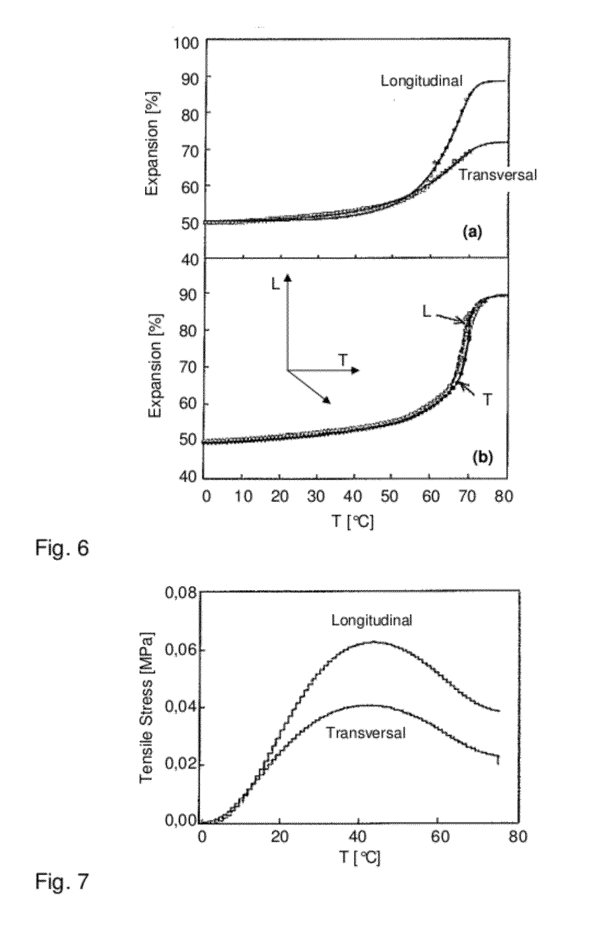

FIG. 6 stress-free temperature-induced recovery behavior of a programmed anisotropic (a) and isotropic (b) SMP foam;

FIG. 7 temperature-induced recovery behavior of a programmed anisotropic (a) SMP foam under load, and

FIG. 8 stress-free temperature-induced recovery behavior of a programmed anisotropic (a) SMP foam at two different programming temperatures.

The shape memory polymer is a polymer network having a thermally inducible shape memory effect (SMP). The network formation can be achieved by covalent bonds or by physical interactions such as electrostatic effects. In addition to the crosslinking points the polymer network comprises at least one kind of switching segment which has a material-dependent transition temperature, such as a crystallization temperature or glass transition temperature. There are numerous descriptions in the literature of polymer networks that have a shape memory effect. Basically, the present invention is not limited to a special material. For example, the polymer network may comprise a switching segment that is selected from the group of polyesters, especially poly(ε-caprolactone); polyethers, polyurethanes, especially polyurethane; polyimides, polyetherimides, polyacrylates, polymethacrylates, polyvinyls, polystyrenes, polyoxymethyls, poly(para-dioxanone) or others. It is also conceivable that the polymer network comprises two or more different switching segments from the aforementioned group or others. In this case, at least one switching segment is preferably selected such that its switching temperature falls within an acceptable range for the respective application. Optionally, the shape memory polymer may comprise hydrolytically cleavable groups, in particular diglycolides, dilactides, polyanhydrides or polyorthoesters. In this way, biodegradable materials are obtained, which can be advantageous particularly for applications in the biomedical field. Even biodegradable shape memory polymers are sufficiently known from the literature. The present invention is not limited to any specific members of this group.

The present invention relates to a foam material which is manufactured from such a shape memory polymer and which comprises an asymmetric pore morphology having substantially uniformly oriented pores, which provides the foam with an anisotropic shape memory behavior. The morphology is influenced specifically by the choice of process parameters and/or the properties of the process container in which the foaming is carried out.

FIG. 1 exhibits schematically an apparatus 10 for implementing the foaming process according to the invention. The apparatus 10 comprises a pressure container 12 for accommodation of a process container 14 shown in FIG. 2 containing the sample to be foamed. The pressure container 12 has an insulating double jacket for temperature control which is connected to a thermostat 16 via coolant-carrying pipes.

A test chamber within the pressure container 12 is connected by a piping system to a propellant storage tank 18 which in particular contains CO₂. The temperature control and pressure setting of the propellant to be applied to the pressure container 12 takes place by means of a heat exchanger 20 and a combined pump heat exchanger module 22. The heat exchanger 20 and the heat exchanger of the pump heat exchanger module 22 are connected to a cryostat 24 by coolant-carrying pipes. The propellant supply may be interrupted by means of a shut-off 26, 28 fitted in each case on the suction side and on the pressure side.

By one or two ventilation valves 30 comprising a controllable release module 32, which is arranged in signal connection to a pressure transmitter 34 for measuring and transmitting the pressure in the pressure container 12 and in the pipe on the pressure side, a controlled ventilation of the pressure container 12 is enabled.

FIGS. 2a and 2b show two examples of the process container 14 which accommodates the sample to be foamed, that may be applied in the context of the present invention. There are in each case containers open on one side (above) or on two sides (above and below) having, for example, a square or rectangular (FIG. 2a) or round (FIG. 2b) plan view. It is advantageous, in each case, that the height H of the container is greater than the longest side length B or the diameter B of the container. Preferably, the geometry of the process container is selected such that H≧1.5 B, i.e. that the height H is at least half the (longest) side length B or diameter B. It is preferably H≧2 B, and particularly preferably H≧3. By selecting the height/width ratio of the process container, the degree of asymmetry of the generated pores may be determined.

The foaming apparatus 10 shown in FIG. 1 exhibits the following functionality. A sample of a shape memory polymer to be foamed is inserted into a process container 14, for example, according to FIG. 2a or 2b, and this is inserted into the pressure container 12 and the temperature is controlled by the thermostat 16 to a predetermined process temperature. After opening the suction and pressure shut-offs (valves) 26 and 28 the filling of the pressure container 12 begins. The liquid CO₂ flows from the storage tank 18 to the pressure balance in the pressure container 12. In order to adjust the pressure in the pressure container 12 to the desired saturation pressure, the CO₂ kept liquid by cooling with the heat exchanger 20 must be compressed by the pump heat exchanger module 22. In the pressure container 12 the transition into the supercritical range takes place at approximately 73.7 bar and at above 31° C. It dissolves the scCO₂ in a shape memory polymer, wherein a single-phase solution is formed. The application is continued until a predetermined saturation of the polymer dependent on the process parameters temperature and pressure with the CO₂ ceases.

Then the shut-off 26 and/or 28 closes and a controlled ventilation of the pressure container 12 takes place with the aid of the controllable release module 32, wherein the ventilation valves 30 are controlled to such an extent while detecting the pressure by means of a pressure transmitter 34 that a predetermined ventilation rate is adjusted. A degassing of the CO₂ from the polymer material results due to the drop in pressure. The previously existing single-phase solution of the scCO₂ in the polymer makes a transition into a two-phase system (solid polymer/gaseous CO₂). This phase separation results in the desired foaming of the polymer, while the gaseous CO₂ escapes.

FIG. 3 illustrates an exemplary chronological sequence of the process parameters of pressure and sample temperature during the foaming process. It can be divided into three phases. In Phase I, which begins with the opening of the shut-off 28 and thus the application of the pressure container 12 and the polymer sample with the CO₂, the pressure build-up in the pressure container 12 takes place until a pressure of approximately 100 bar, for example, is achieved there. At that point in time begins Phase II (diffusion phase), in which the saturation of the polymer with the propellant takes place during which the pressure remains approximately constant and the temperature reaches its predetermined nominal value. If the equilibrium is achieved, Phase III begins with the controlled pressure release, during which the drop in pressure is created and the foam formation takes place. By lowering the temperature (cooling) the foamed sample is stabilized.

By using a preferably elongated process container with one or both sides open according to FIG. 2 a gas flow of the propellant escaping during Phase III (see FIG. 3) directed substantially parallel to the side walls of the container in the longitudinal spatial direction L is achieved (see coordinates defined in FIG. 2). As a result an asymmetric pore structure of the foam produced occurs, in which the pore length is significantly greater than the pore diameter. Moreover, the pores are substantially uniform in orientation, particularly along the main flow direction of the propellant, i.e. parallel to the container side walls in the longitudinal spatial direction L. Through selection of the process container, particularly its height/width ratio, and its basic form, as well as through the process parameters of foaming temperature, degree of saturation of the polymer with the propellant and the stress release rate (ventilation rate), the porosity, the pore size, the pore size distribution, the foam density and the extent of the pore asymmetry, i.e. the ratio of the pore length to the pore diameter, can be influenced. The ventilation rate thus plays a particularly important role with regard to pore size, foam density and mechanical compressibility. A large average pore size (500±50 μm) with a high density (0.3±0.05 g/cm³), lower compressibility and higher stiffness were obtained at low ventilation rates (<10 bar/s). However, foams with lower density (0.11±0.02 g/cm³), small pore sizes (150-200 μm) and very good thermomechanical recovery behavior were aimed at the tested system at temperatures of 78-84° C. with high ventilation rates (25 bar/s).

Subsequently, the principle of the present invention is described by an asymmetric foam from a multiblock copolymer (PDLCL), manufactured by linking the macrodiols of poly(ω-pentadecalactone) PPDL and poly(ε-caprolactone) PCL by means of a co-condensation. In the polymer PDLCL the PPDL acts as a crystallizable hard segment (Tₘ(PPDL)=82° C.) and PCL also acts as a crystallizable soft segment (Tₘ(PCL)=48° C.). Both segments are linked together covalently using hexamethylene diisocyanate as a link.

1. Manufacture of the Multiblock Copolymer PDLCL from Poly(ω-pentadecalactone) and Poly(ε-caprolactone)

Both terminal macrodiols poly(ω-pentadecalactone)-diol (PPDL-diol; Mₙ=2200 g·mol⁻¹ and Tₘ=89° C., self-synthesized) and poly(ε-caprolactone)-diol (PCL-diol; Mₙ=3200 g·mol⁻¹ and Tₘ=44° C., Solvay, UK) were reacted with hexamethylene diisocyanate (HMDI; Fluka, Germany) and dibutyltin laurate in 1,2-dichlorethane at 80° C. The product PDLCL was obtained by precipitation in methanol at −10° C. Details of the production are described in K. Kratz, U. Voigt, W. Wagermaier, A. Lendlein: “Shape-memory properties of multiblock copolymers consisting of poly(ω-pentadecalactone) hard segments and crystallizable poly(ε-caprolactone) switching segments”, in Advances in Material Design for Regenerative Medicine, Drug Delivery, and Targeting/Imaging, edited by V. Prasad Shastri, A. Lendlein, L-S. Liu, A. Mikos, S. Mitragotri (Mater. Res. Soc. Symp. Proc. Volume 1140, Warrendale, Pa., 2009) and S. A. Madbouly, K. Kratz, F. Klein, K. Lutzow, A. Lendlein: “Thermomechanical behaviour of biodegradable shape-memory polymer foams”, in Active Polymers, edited by A. Lendlein, V. Prasad Shastri, K. Gall (Mater. Res. Soc. Symp. Proc. Volume 1190, Warrendale, Pa., 2009).

The PDLCL had a weight content of 60% by weight PCL and 40% by weight PPDL (measured in deuterated chloroform with tetramethylsilane as an internal standard) in accordance with ¹H-NMR analysis (500 MHz Bruker Advance Spectrometer, Germany).

To calculate the molecular weight Mₙ and the molecular weight distribution (polydispersity PD) GPC measurements were performed based on conventional calibration methods using polystyrene standards with Mₙ between 1000 and 3,000,000 g/mol (Polymer Standards Service GmbH, Germany). The PDLCL had a molecular weight Mₙ=58,000 g/mol and a polydispersity of 2.2.

### 2. Foaming Process

Prior to foaming the PDLCL raw material was granulated at 95° C. in a single-screw extruder (Thermo Electron I/d 34, d=19 mm).

The foaming process was performed using a foaming apparatus according to FIG. 1 in accordance with the previously described process of the invention. For this purpose, the polymer sample with supercritical carbon dioxide (scCO₂) was applied at 79° C. and a constant pressure of 200 bar until the setting of a saturation equilibrium for at least approximately 30 minutes. After 60 minutes (inclusive of the filling) the ventilation program was initiated, wherein the controlled ventilation valves (Imago 500) were open, so that a pressure release was set at a rate of 25 bar/s. This very rapid ventilation rate resulted in a separation and expansion of the CO₂ dissolved in the polymer and thus in the foaming of the polymer material. After reaching the ambient air pressure, the foam samples were removed from the container and stored under room conditions for 24 hours.

To produce the anisotropic foams according to the invention small glass beakers (29 mm diameter, 50 mm height) were used as process containers 14 for the foaming, i.e. with a cylindrical shape as shown in FIG. 2b. During the sudden increase in pressure the escaping CO₂ flowed along a main flow direction substantially parallel to the lateral walls of the beakers. This construction is outlined in FIG. 4a, in which the vertical arrows represent the longitudinal main flow direction L of the exiting CO₂.

As a comparative test samples were foamed in the same manner, but with an all-round gas permeable container made of a closed metal mesh found having a mesh size in the micrometer range (FIG. 4d) used instead of the beaker. A container with a gas-permeable membrane may also be used with the same result. Thereby the polymer material is present in the form of granules. Under these conditions during the rapid ventilation the CO₂ escaped almost uniformly in all spatial directions from the foaming sample and the container (see arrows in FIG. 4d).

### 3. Porosity and Foam Morphology

The pore size distributions were determined by mercury porosity measurements (Mercury Porosimeter Pascal 140 and 440, Fisons Instruments, Italy).

The porosity and the relative proportions of open pores accessible to a displacement medium was determined by pycnometric measurements according to the instructions of the device manufacturer in a 60 cm³ test cell at 20° C. (Ultrafoam Pycnometer 1000, Quantachrome Instruments, USA) using nitrogen as a displacement medium (6 psi) and with measurements repeated ten times. The absolute porosity resulted from the ratio of the volume of the foamed sample to the volume of the unfoamed sample. All samples exhibited a high degree of porosity of approximately 89±4% and a fraction of open-cell pores of approximately 41±4% based on the number of all pores. The foam density was calculated from the geometric volume and the mass of the foam sample.

To determine the pore structure of the foams manufactured according to the process according to the invention and in a comparative test the foamed samples after storage for a few minutes in liquid nitrogen were sliced in each case in the longitudinal direction L and the transverse direction T. (For definition of the longitudinal L and transverse spatial direction T refer to the coordinate system in FIG. 4 above.) The sliced samples were attached to supports and sputtered in a Magnetron (Emitech, UK). The samples prepared in this way were examined under an electron microscope using a Schottky emitter (LEO 1550 VP, Germany).

The SEM images of the comparative sample (FIGS. 4c and 4f) show that the pores exhibit a uniform expansion in all spatial directions and accordingly have no uniform orientation. Rather, the pores in the longitudinal cutting direction (FIG. 4c) and transverse cutting direction (FIG. 4f) resemble each other and have an almost symmetrically round shape in all spatial directions.

On the other hand the pores of the foamed sample according to the process according to the invention show dramatic differences in the longitudinal cutting direction (FIG. 4b) and transverse cutting direction (FIG. 4c). While the transverse section in FIG. 4c shows an almost round pore cross-section similar to the isotropic sample, a significantly elongated pore geometry substantially having pores oriented uniformly in the longitudinal spatial direction L is apparent. This means that the pores of the anisotropic sample according to the invention have a much longer extension along the main flow direction L of the escaping carbon dioxide during the foaming than in the plane extending orthogonally to the main flow direction L. The pore geometry can be described approximately as cylindrical, wherein an average pore diameter of 150 μm and an average pore length of 900 μm was calculated (SIS Soft Imaging Solutions, Scandium Software, Olympus GmbH). This corresponds to a length to width ratio of 6.

### 4. Mechanical Properties of the Unprogrammed Samples

For the examination of mechanical properties of the unprogrammed sample square specimens with side lengths of 12 mm were cut from the anisotropic and isotropic PDLCL foams. Compression-stress measurements for these samples were taken in each case in longitudinal and transverse directions at 25° C. using a tensile stress device (Instron 3345) with a 500 N load cell. The measurements were taken with a constant compression rate of 3.0 mm/min while recording the stress. Each measurement was repeated with five samples and formed the averages.

The result is shown in FIG. 5, in which the measured stress is represented as a function of the percentage compression of the sample. For all measurements the cell walls of the pores deform in the initial elastic regime before the material undergoes a plastic deformation in a further procedure. Finally, with a further increase in the compression the cells coincide so that the samples behave as a compact material and the stress increases dramatically. In the case of the isotropic comparative sample (FIG. 5b) the stress extensions under compression in the longitudinal direction L and in the transverse direction T reveal almost identical courses. In contrast, clear differences between the measurements in both spatial directions are to be determined for the anisotropic sample according to the invention (FIG. 5a). It appears that the material stress in the longitudinal direction L over the entire compression area is greater than in the transverse direction T. In particular, for a lower compressive load up to approximately 10% the longitudinal stress distribution shows a markedly steeper rise than the transverse (see enlarged section in FIG. 5a). This means that when compressed in the longitudinal direction the pores offer a higher mechanical resistance than when compressed in the transverse direction. These measurements show that the foam according to the invention comprises anisotropic mechanical properties even without thermomechanical programming.

### 5. Thermomechanical Programming of the Foam Samples

Square samples of PDLCL foams with side lengths of 12 mm were subjected to a three-stage thermomechanical process for programming a temporary shape in order to examine the shape memory behavior: first, the sample (present in its production-related permanent shape) was heated to a temperature T_{high}=70° C. and annealed at this temperature for 5 minutes to remove any possible thermal or mechanical record of the foam. In a second step, the foam body was brought to the programming temperature T_{prog}=60° C., i.e. above the melting temperature of PCL (Tₘ=48° C.) and below the melting temperature of PPDL (Tₘ=82° C.) and deformed at this temperature to a predetermined degree of compression (εₘ=50, 65 or 80%). Subsequently, while maintaining the compression force the foam was cooled at a rapid cooling rate of 30° C./min to T_{low}=0° C. and maintained at this temperature for 10 minutes.

This procedure was performed both with the anisotropic foams according to the invention as well as with the isotropic comparative foams, wherein the compression took place in each case in the longitudinal and in the transverse direction.

### 6. Shape Memory Behavior

The samples programmed in accordance with the 5th process were subjected to thermomechanical tension tests using a tension measurement device with a thermostatically controllable chamber (Zwick Z1.0 and Zwick 005). For this purpose, the samples were heated at a heating rate of 1° C./min to a temperature of T_{high}=70° C. to resolve the shape transition from the programmed temporary shape (compressed form) to the permanent shape. The programming steps and the subsequent recovery were repeated cyclically. Two different measurement modes were used in the recovery: the load-free recovery, during which the expansion of the sample was achieved as a function of temperature, as well as the recovery under a constant expansion of 50%, wherein the compressive stress was measured as a function of temperature. In the case of stress-free recovery the characteristic switching temperature T_{switch} results from the turning point of the expansion temperature curve, while during the recovery under load the stress temperature curve has a characteristic maximum of T_{σ,max}.

The strain curves of the load-free recovery are shown in FIG. 6 for the anisotropic sample (a) and for the isotropic sample (b). It is apparent that the anisotropic sample has a different recovery behavior in the longitudinal and transverse direction. In particular, it exhibits a recovery rate Rᵣ of approximately 88% in the longitudinal direction which is higher by approximately 20% than in the transverse direction. In contrast, as expected, the isotropic sample shows consistent recovery behaviour with a recovery rate Rᵣ of approximately 84% for both spatial directions L and T. The characteristic switching temperature T_{switch}, defined by the polymer composition-dependent and melting transition of PCL, is the same for all samples and spatial directions.

The anisotropic foam recovered under load in FIG. 7 exhibits well-defined characteristic maxima T_{σ,max} at approximately 48° C. after both longitudinal and transverse compression. Here, too, the temperature stress curve obtained after longitudinal programming has a higher value for εₘ than after transverse programming.

Finally, FIG. 8 shows temperature strain curves of the load-free recovery of an anisotropic foam after longitudinal compression at alternate programming temperatures (T_{prog}=40° C. and 60° C.). This experiment demonstrates that, as with other (isotropic) shape memory polymers, the switching temperature can be controlled by the temperature used during programming. In particular, after deformation at 40° C., the foam exhibits a switching temperature T_{switch} lower by approximately 10 K than after programming at 60° C. This phenomenon is also referred to as a temperature memory effect (TME).

### REFERENCE CHARACTERS

10 Foaming apparatus
12 Pressure container
14 Process containers
16 Thermostat
18 Propellant storage tank
20 Heat exchanger
22 Pump heat exchanger module
24 Cryostat
26 Shut-off
28 Shut-off
30 Ventilation valve
32 Controllable release module
34 Pressure transmitter

1. A molded foam body having anisotropic, thermally inducible shape memory properties, comprising at least one shape memory polymer which, after a mechanical or thermomechanical programming, is able to execute at least one shape transition temperature-induced from a temporary shape to a permanent shape, characterized in that the unprogrammed shape memory polymer exhibits a foam structure having asymmetric pores, oriented substantially in a common, first spatial direction, wherein a ratio of an average pore dimension in the first spatial direction to an average pore dimension in a second spatial direction extending orthogonally thereto is at least 2.

2. The molded foam body according to claim 1, wherein a ratio of an average pore dimension in the first spatial direction to an average pore dimension in a second spatial direction extending orthogonally thereto is at least 3, preferably at least 4, especially preferably at least 5.

3. The molded foam body according to claim 1, wherein a density of the molded foam body is located within the range of 0.01 to 0.30 g/cm³, particularly 0.02 to 0.20 g/cm³, preferably 0.07 to 0.13 g/cm³.

4. The molded foam body according to claim 1, wherein the shape memory polymer is a physically or covalently crosslinked polymer network which exhibits at least one switching segment that is selected from the group consisting of polyesters, especially poly(ε-caprolactone); polyethers, polyurethanes, especially polyurethane; polyimides, polyetherimides, polyacrylates, polymethacrylates, polyvinyls, polystyrenes, polyoxymethyls, poly(para-dioxanone).

5. The molded foam body according to claim 1, wherein the shape memory polymer includes hydrolytically cleavable groups which are especially selected from the group consisting of glycolides, lactides, diglycolides, dilactides, polyanhydrides and polyorthoesters.

6. An article comprising or consisting of a molded foam body according to claim 1.

7. The article according to claim 6, wherein the article is an object for use in the medical, pharmaceutical or biochemical field.

8. A method for manufacturing a molded foam body having anisotropic, thermally inducible shape memory properties according to claim 1 having the steps
a) manufacture of a substantially homogeneous mixture of a melt of a shape memory polymer which, after a programming, temperature-induced, is able to execute at least one shape transition from a temporary shape to a permanent shape, and of a propellant or a chemical precursor of such, the propellant or the precursor being present in a first state; and
b) transfer and release of the propellant into a second, gaseous state in such a way that the shape memory polymer and the propellant separate, wherein process parameters of the release and a geometry of a process container, in which the release of the propellant takes place, are selected in such a way that the released gaseous propellant substantially escapes from the shape memory polymer along a predetermined main flow direction, so that the shape memory polymer forms a foam structure having asymmetric pores, oriented substantially in a common, first longitudinal spatial direction corresponding to the main flow direction, wherein the geometry of the process container is selected so that this is open on one or both sides in the longitudinal spatial direction and is closed in the other spatial directions and so that the mixture of the shape memory polymer and the propellant occupies a column in the process container, which column in the longitudinal direction has a greater extent than in a transverse direction extending orthogonally thereto.

9. The method according to claim 8, wherein in a further step (c) the molded foam body is deformed for its thermomechanical programming at a material temperature above a switching temperature of the shape memory polymer using a deformation constraint and is cooled while maintaining the deformation constraint at a temperature below the switching temperature.

10. The method according to claim 8, wherein, as the propellant, a physical propellant is used which under the temperature and the pressure of step (a) exists in a liquid, solid or supercritical state, and its release in step (b) is effected by the temperature and/or the pressure being altered such that the propellant passes over into the gaseous state.

11. The method according to claim 10, that as the propellant carbon dioxide is used which is present in step (a) in a supercritical state and by reducing the pressure in step (b) passes over into the gaseous state.

12. The method according to claim 10, wherein in step (b) the propellant is released by reducing the pressure, wherein the pressure is reduced especially at a rate of at least 10 bar/s, preferably of at least 15 bar/s, especially preferably of at least 20 bar/s.

13. The method according to claim 8, wherein in step (a) a propellant existing in a liquid or supercritical state is used, in which a further substance, especially a pharmaceutical active substance, is dissolved.
